(19) United States
(12) Patent Application Publication
(10) Pub. No.: US 2004/0077225 A1
(43) Pub. Date: Apr. 22, 2004

(54) Electrical connector with movable pin

(75) Inventor: Chien Chun-Fu, Shu-Lin City (TW)

Correspondence Address: TROXELL LAW OFFICE PLLC, SUITE 1404, 5205 LEESBURG PIKE, FALLS CHURCH, VA, 22041, US

(73) Assignee: L & K Precision Industry Co., Ltd.

(21) Appl. No.: 10/274,133

(22) Filed: Oct. 21, 2002

(51) Int. Cl. H01R 13/24

(52) U.S. Cl. 439/700

(57) ABSTRACT

An electrical connector includes a housing, a number of terminals, a number of pins, and a number of springs. The housing defines a plurality of receiving chambers. The terminals are respectively received in the receiving chambers of the housing. Each terminal defines a receiving hole therein. Each pin has a first contact portion projecting from the housing and a second contact portion opposite the first contact portion and movably received in the receiving hole of the terminal. The springs are respectively received in the receiving holes of the terminals. Each spring has a first end abutting against the second contact portion of the pin. When the pin is pressed, the spring actuates the pin to be biased and contact the inner surface of the terminal thereby causing a stable electrical connection between the pin and the terminal.

### BACKGROUND OF THE INVENTION

1. Field of the Invention

The present invention relates to an electrical connector, and particularly to an electrical connector with a movable pin and ready to manufacture.

2. Prior Art

A conventional electrical connector for a chargeable battery or a liquid crystal display (LCD) includes a dielectric housing, a metallic pin and a screwy spring. The pin and the spring are received in the housing. The pin has a contact portion at an end thereof projecting from the housing for electrical contact with the chargeable battery or the LCD, and a press portion at the other end thereof for pressing the spring and electrical contact with the spring. When the electrical connector is connected with the chargeable battery or the LCD, the contact portion of the pin is pressed by the battery or the LCD and thus the press portion of the pin is moved to press the spring. The spring is electrically connected with a printed circuit board (PCB). Thus, the chargeable battery or the LCD is connected with the PCB via the connector.

However, the screwy spring defines a long transmission path which results in a high resistance. Furthermore, when the spring is compressed and deformed, the transmission path is changed and the resistance is varied consequently, which adversely affects the electrical transmission between the PCB and the battery or the LCD.

To overcome the above shortcomings, as shown in FIG. 1, another conventional electrical connector 5 includes a housing (not labeled), a columned terminal 51 received in the housing, a spring 52 received in the terminal 51 and a pin 53 partially received in the terminal 51. The pin 53 has a first contact portion 531 projecting from the housing for electrically connecting with a battery or a LCD, and a second contact portion 532 abutting against the spring 52 and electrically connecting with an inner wall of terminal 51 The terminal 51 is plated with gold for stable transmission between the inner wall of the terminal 51 and the second contact portion 532 of the pin 53. An electrical transmission path is formed by the pin 53 and the terminal 51 without the spring 52 and thus the path is short.

However, it is precise and complicated to keep the second contact portion 532 of the pin 53 movable along and engagingly contacting the inner wall of the terminal 51. Thus, it is complicated and low efficient to manufacture the pin 53 and the terminal 51. Furthermore, the transmission between the pin 53 and the terminal 51 is unstable.

Additionally, outer and inner surfaces of the terminal 51 are plated with gold due to the whole immerged plating process. However, it is unnecessary to plate the outer surface and it unnecessarily increases the cost of the connector.

### SUMMARY OF THE INVENTION

Accordingly, an object of the present invention is to provide an electrical connector which defines a short electrical transmission path with a low resistance and provides stable transmission.

A further object of the present invention is to provide an electrical connector which is ready to manufacture with low cost.

To achieve the above-mentioned objects, an electrical connector in accordance with the present invention includes a housing, a number of terminals, a number of pins, and a number of springs. The housing defines a plurality of receiving chambers. The terminals are respectively received in the receiving chambers of the housing. Each terminal defines a receiving hole therein. Each pin has a first contact portion projecting from the housing and a second contact portion opposite the first contact portion and movably received in the receiving hole of the terminal. The springs are respectively received in the receiving holes of the terminals. Each spring has a first end abutting against the second contact portion of the pin. When the pin is pressed, the spring actuates the pin to be biased and contact the inner surface of the terminal thereby causing a stable electrical connection between the pin and the terminal.

Other objects, advantages and novel features of the present invention will be drawn from the following detailed embodiments of the present invention with attached drawings, in which:

### BRIEF DESCRIPTION OF THE DRAWINGS

FIG. 1 is a cross-sectional view of a conventional electrical connector;

FIG. 2 is an exploded view of an electrical connector in accordance with a first embodiment of the present invention with a housing thereof removed;

FIG. 3 is a cross-sectional and assembled view of FIG. 2;

FIG. 4 is an assembled view of the electrical connector with a section cross cut;

FIG. 5 is a bottom plan view of FIG. 4;

FIG. 6 is similar to the section cross cut in FIG. 4 but showing a pin being moved to engage with a terminal;

FIG. 7 is an assembled view of an electrical connector in accordance with a second embodiment of the present invention with a section cross cut;

FIG. 8 is a bottom plan view of FIG. 7;

FIG. 9 is a cross-sectional view of an electrical connector in accordance with a third embodiment of the present invention showing a pin being moved to engage with a terminal; and

FIG. 10 is a cross-sectional view of an electrical connector in accordance with a fourth embodiment of the present invention.

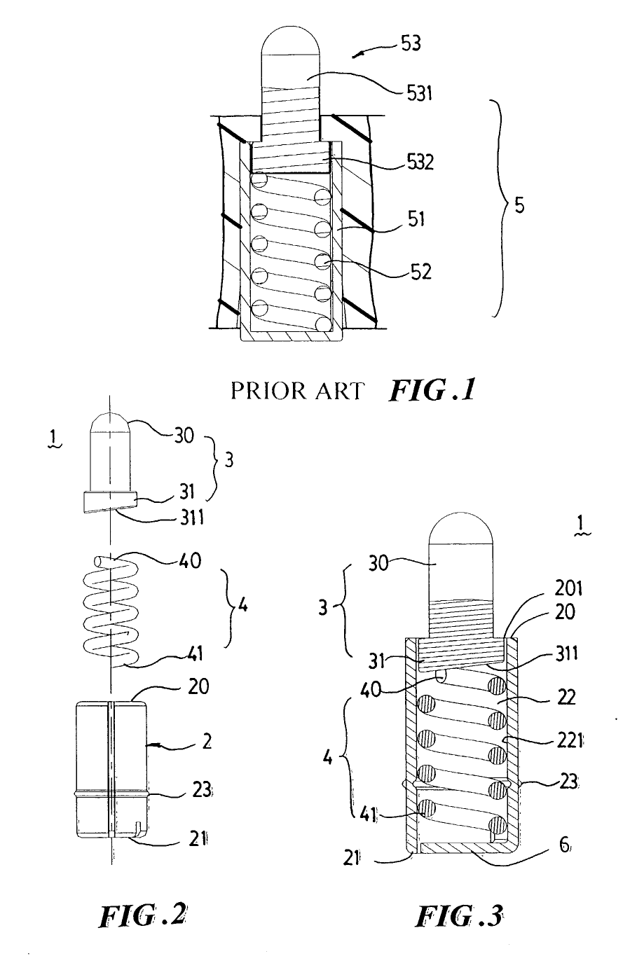

### DESCRIPTION OF THE PREFERRED EMBODIMENTS

Referring to FIGS. 2-5, an electrical connector 1 in accordance with a first embodiment of the present invention includes a dielectric housing 7, a plurality of conductive terminals 2, a plurality of metallic pins 3, and a plurality of springs 4. A plurality of round receiving chambers 70 is defined in the housing 7 from top to bottom. Each receiving chamber 70 receives one terminal 2, one pin 3, and one spring 4 therein.

The terminals 2 are formed from a metal sheet and each shaped as a column, which is ready to manufacture. Each terminal 2 includes a mating end 20 and a mounting end 21 opposite the mating end 20. A mounting portion 6 is formed at the mounting end 21 for mounting on a printed circuit board (not shown). A receiving space 22 is defined in the terminal 2 from the mating end 20 to the mounting portion 6. A hole 201 is defined in the mating end 20 for extension of the pin 3 and the spring 4. An inner surface 221 of the body is plated with gold via a selective plating process for increasing electrical transmission capability thereof. An annular protrusion 23 is formed around the terminal 2 and near the mounting end 21 for interference engaging with the housing 7 thereby securing the terminal 2 in the receiving chamber 70.

The pin 3 is formed from a metal sheet and by stamping, which is ready to manufacture. The pin 3 includes a first round contact portion 30 at one end thereof and a second round contact portion 31 at the other end thereof. The second contact portion 31 has a bigger lateral size than the first contact portion 30 and so the pin 3 is generally inverted T-shaped. A slantwise surface 311 is formed at the bottom of the second contact portion 31 of the pin 3. The first contact portion 30 projects from the housing 7 for electrical connection with a battery (not shown), a liquid crystal display (LCD) (not shown), or other electronic components or devices. The second contact portion 31 is movably received in the receiving space 22 of the terminal 2 and electrically connected with the inner surface 221 of the terminal 2. The spring 4 is received in the receiving space 22 of the terminal 2 with a first end 40 abutting against the slantwise surface 311 of the pin 3 and a second end 41 opposite the first end 40 and abutting against the mounting portion 6 of the terminal 2.

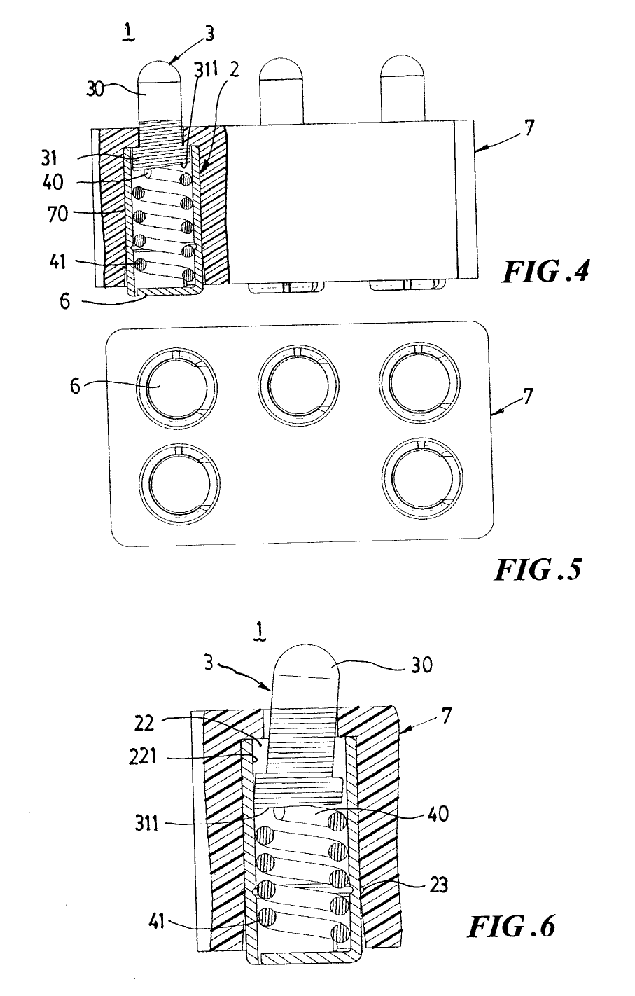

Particularly referring to FIG. 4, in assembly, the terminals 2, the pins 3, and the springs 4 are respectively received in the receiving chambers 70 of the housing 7. The pin 3 and the spring 4 are received in the receiving space 22 of the terminal 2. The first contact portion 30 of the pin 3 projects from the housing 7. The second contact portion 31 of the pin 3 abuts against the housing 7 with the slantwise surface 311 thereof abutting against the first end 40 of the spring 4. The second end 41 of the spring 4 abuts against the mounting portion 6 of the terminal 2.

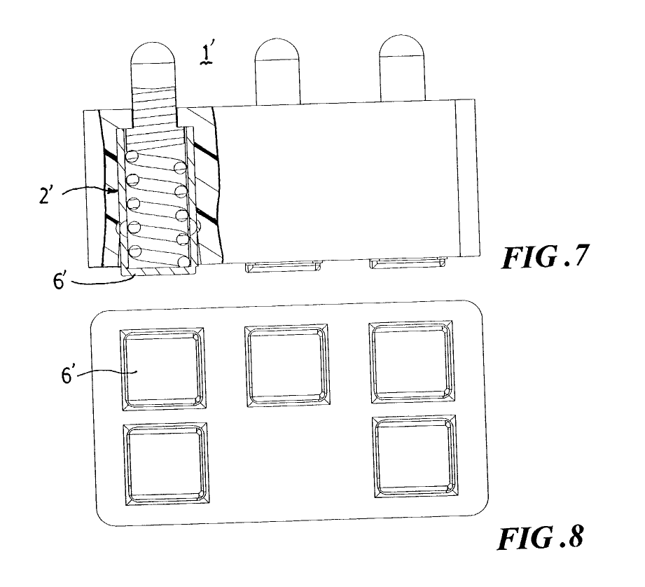

Referring to FIGS. 4 and 6, in operation, the first contact portion 30 of the pin 3 is pressed for electrical connection with the battery, the LCD or others. Consequently, the second contact portion 31 of the pin 3 is moved to engage with the inner surface 221 of the terminal 2 with the spring 4 being pressed. Due to the slantwise surface 311 of the pin 3, the pin 3 is exerted by the spring 4 and biased to cause the stable connection between the second contact portion 31 of the pin 3 and the inner surface 221 of the receiving space 22 of the terminal 2. Thus, a short and stable transmission path is defined by the pin 3 and the terminal 2, which has a low resistance and provides stable electrical transmission.

FIGS. 7 and 8 show an electrical connector 1′ in accordance with a second embodiment of the present invention. The receiving chamber 70 of the housing 7, the terminal 2, and the second contact portion 31 of the pin 3 in the first embodiment are shaped to be rectangular in this embodiment. FIG. 8 shows that the mounting portion 6′ of the terminal 2′ is shaped to be rectangular. Likewise, a short and stable transmission path is defined in the electrical connector 1′, which has a low resistance and provides stable electrical transmission.

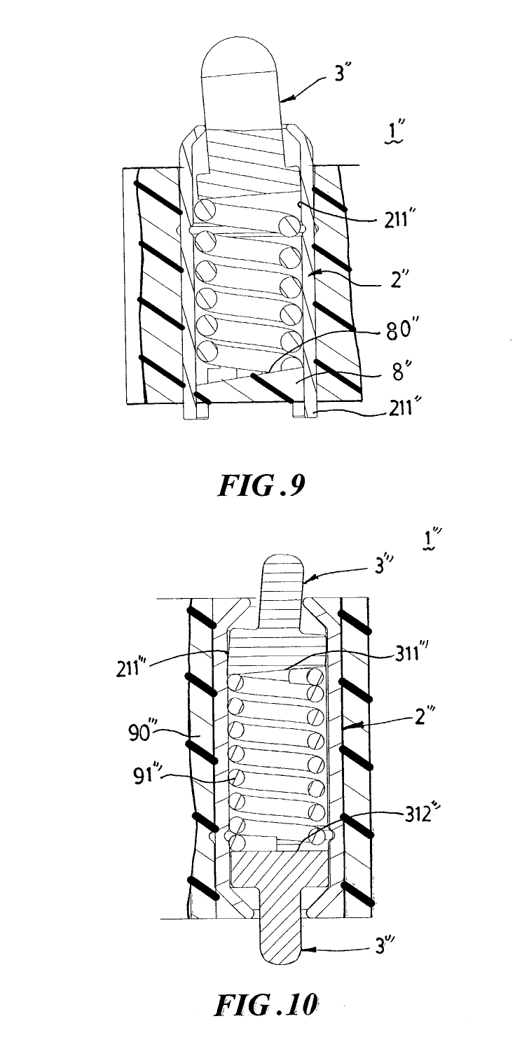

FIG. 9 shows an electrical connector 1″ in accordance with a third embodiment of the present invention including a housing (not labeled), a terminal 2″, a pin 3″ and a spring (not labeled). The terminal 2″ has a pair of mounting tails 211″ which are bent toward each other. A support block 8″ is received in the terminal 2″ and supported by the mounting tails 211″. A slantwise surface 80″ is formed at the top of the support block 8″ for supporting the spring. The pin 3″ has a generally horizontal surface (not labeled) at the bottom thereof supported by the spring. When the pin 3″ is pressed and moved to engage with the inner surface 211″ of the terminal 2″, the pin 3″ is exerted by the spring and biased to cause the stable connection between the pin 3″ and the terminal 2″ due to the slantwise surface 80″ of the support block 8″. Thus, a short and stable transmission path is formed by the pin 3″ and the terminal 2″, which has a low resistance and provides stable electrical transmission.

FIG. 10 shows an electrical connector 1′″ in accordance with a fourth embodiment of the present invention for an LCD. The electrical connector 1′″ includes a housing 90′″, a terminal 2′″ received in the housing 90′″, a spring 91′″ received in the terminal 2′″, upper and lower pins 3′″ securing the spring therebetween. A slantwise surface 311′″ is formed at the upper pin 3′″ for abutting against the end of spring 91′″. A horizontal surface 312′″ is formed at the lower pin 3′″ for abutting against the other end of spring 91′″. When the upper and lower pins 3′″ are pressed and moved to engage with the inner surface 211′″ of the terminal 2′″, the pins 3′″ are exerted by the spring and biased to cause the stable connection between the pins 3′″ and the terminal 2′″ due to the slantwise surface 311′″ of the upper pin 3′″. Thus, a short and stable transmission path is defined by the pins 3′″ and the terminal 2′″, which has a low resistance and provides stable electrical transmission.

It is understood that the invention may be embodied in other forms without departing from the spirit thereof. Thus, the present examples and embodiments are to be considered in all respects as illustrative and not restrictive, and the invention is not to be limited to the details given herein.

1. An electrical connector for assembly into a chargeable battery with a plurality of receiving chambers comprising:
a plurality of terminals respectively received in the receiving chambers, each terminal defining a mating end with a hole and a mounting end opposite the mating end and a receiving space defined in the terminal from the mating end to the mounting portion and a mounting portion formed at the mounting end;
a plurality of pins each having a first contact portion projecting from the hole of the mating end and a second contact portion opposite the first contact portion and movably received in the receiving space of the terminal and a slantwise surface is formed at the second contact portion of the pin; and
a plurality of springs respectively received in the receiving space of the terminals, each spring having a first end abutting against the slantwise surface of the second contact portion of the pin and a second end opposite the first end and abutting against the mounting portion of the terminal;
wherein when the pin is pressed, the spring actuates the pin to be biased and contact an inner surface of the receiving space of the terminal thereby causing a stable electrical connection between the pin and the terminal.

2. The electrical connector as claimed in claim 1, wherein the terminal is formed from a metal sheet and shaped as a column.

3. The electrical connector as claimed in claim 1, wherein the terminal is formed from a metal sheet and shaped to be rectangular.

4. The electrical connector as claimed in claim 1, wherein the pin is formed from a metal sheet and shaped as round.

5. The electrical connector as claimed in claim, 1, wherein the receiving space of an inner surface of the terminal is plated in a selective plating process.

6. The electrical connector as claimed in claim 1, wherein further comprising an annular protrusion is formed around the terminal and near the mounting end.

7. An electrical connector for assembly into a liquid crystal display (LCD) with a plurality of receiving chambers comprising:
a plurality of terminals respectively received in the receiving chambers, each terminal defining a mating end and a mounting end opposite the mating end and a receiving space defined in the terminal from the mating end to the mounting portion and a mounting portion formed at the mounting end as well a hole respectively disposed on the mating end and the mounting portion;
a plurality of pins each the receiving space of the terminal receives two pins, and wherein one of two pins has a slantwise surface abutting against the spring, and each pin having a first contact portion projecting from the hole of the mating end and the mounting portion, a second contact portion opposite the first contact portion and received in the receiving space of the terminal; and
a plurality of springs respectively received between the pins, each spring having a first end and a second end opposite the first end abutting against the second contact portion of the pins;
wherein when the pins is pressed, the spring actuates the one of the pins with a slantwise surface to be biased and contact an inner surface of the receiving space of the terminal thereby causing a stable electrical connection between the pin and the terminal.

8. The electrical connector as claimed in claim 7, wherein the pin with a slantwise surface is disposed on the mating end of the terminal.

9. The electrical connector as claimed in claim 7, wherein the terminal is formed from a metal sheet and shaped as a column.

10. The electrical connector as claimed in claim 7, wherein the pin is formed from a metal sheet and shaped as round.

11. The electrical connector as claimed in claim 7, wherein the receiving space of an inner surface of the terminal is plated in a selective plating process.

12. The electrical connector as claimed in claim 7, wherein further comprising an annular protrusion is formed around the terminal and near the mounting end.

13. An electrical connector for assembly into a chargeable battery with a plurality of receiving chambers comprising:
a plurality of terminals respectively received in the receiving chambers, each terminal defining a mating end with a hole and a mounting end opposite the mating end and a receiving space defined in the terminal from the mating end to the mounting end;
a support block receiving near the mating end and within the receiving space of the terminal, and a slantwise surface is formed at the support block;
a plurality of pins each having a first contact portion projecting from the hole of the mating end and a second contact portion opposite the first contact portion and movably received in the receiving space of the terminal; and
a plurality of springs respectively received in the receiving space of the terminals, each spring having a first end abutting against the second contact portion of the pin and a second end opposite the first end abutting against the slantwise surface of the support block;
wherein when the pin is pressed, the spring actuates the pin to be biased and contact an inner surface of the receiving space of the terminal thereby causing a stable electrical connection between the pin and the terminal.

14. The electrical connector as claimed in claim 13, wherein the receiving space of an inner surface of the terminal is plated in a selective plating process.

15. The electrical connector as claimed in claim 14, wherein further comprising an annular protrusion is formed around the terminal and near the mounting end.
